(19) United States
(12) Patent Application Publication
(10) Pub. No.: US 2025/0271328 A1
(43) Pub. Date: Aug. 28, 2025

(54) METHOD FOR DETERMINING THE EXPECTED NOISE EMISSIONS OF A GEAR PAIR

(71) Applicant: KISSSOFT AG, Bubikon (CH)

(72) Inventor: Hanspeter Dinner, Menzingen (CH)

(21) Appl. No.: 18/857,845

(22) PCT Filed: Apr. 25, 2023
(86) PCT No.: PCT/EP2023/060850

§ 371 Date: Oct. 18, 2024

(30) Foreign Application Priority Data
Apr. 26, 2022 (DE) 10 2022 001 447.5

(51) Int. Cl. G01M 13/021

(52) U.S. Cl. CPC G01M 13/021

(57) ABSTRACT

The invention relates to a method for determining the expected noise emissions of a gear pair, in which method the tooth flanks of a gear of the pair are measured and, from the measurement data thereby obtained, the deviation of the measured tooth flank surfaces from a predefined target profile of this surface is determined, and in which method, on the basis of this deviation, a simulation in the form of a contact analysis under load is carried out for the gear pair, wherein the contact analysis is based not on the deviation as a whole but rather on only a portion of the deviation specifically selected in the complementary space.

The invention is in the field of transmission engineering and gearing technology. It is well known that the mesh of two torque-transmitting gears, i.e. a gear pair, in a transmission creates the risk of unwanted noise emission, not least in gear drives of electric vehicles. The current strategy of vehicle manufacturers is basically to demand high to very high quality for the production of gears according to ISO 1328 since it is well known that a high level of precision of the gears used not only allows the service life to be increased, but also allows noise to be improved through lower vibration excitation (so-called NVH, noise vibration-harshness performance).

There are numerous factors influencing noise development, and when designing the gear pairing for a transmission, unwanted noise can still develop despite the required high quality. It is therefore quite common that, after the design and manufacture of the gears, which move within the desired tolerances, simulation or practical testing of the transmission in use under load by contact analysis, undesirable noise development is detected.

In this respect, the invention specifically relates to a method for determining the expected noise emissions of a gear pair, in which method the tooth flanks of a gear of the pair are measured and from the measurement data thereby obtained, the deviation of the measured tooth flank surfaces from a predefined target profile of this surface is determined, and in which method on the basis of this deviation, a simulation in the form of a contact analysis under load is carried out for the gear pair.

Due to the above-mentioned problems, the invention is based on the object of making a contribution to providing low-noise gear pairs for transmissions.

From a process engineering point of view, this invention is solved by the fact that the contact analysis is not based on the deviation as a whole but only on a specifically selected portion of the deviation in the complementary space.

Within the scope of the invention, it has been recognized that the data provided by gear testing machines, which data represent the surface deviation from the ideal target tooth flank, are not well suited in this form to offer conclusions about the expected noise emission development. According to the invention, it is therefore provided to work using the complementary space. One potential design option would be a frequency domain, for example through Fourier transformation, and the consideration of the resulting spectral weights for the individual spatial frequencies, but also other transformations to break down the measurement data into spectral components. Furthermore, the invention is based on the realization that waviness with wavelengths of the order of magnitude of the toothing geometries, such as height in profile direction or toothing width, play a significant role in noise development. This has been discussed in modern research for some time, but it is controversial. The effects of waviness do not seem to be clear: it does seem logical that waviness on the tooth flank can or should be the cause of unwanted vibration excitation and therefore noise development, but how exactly and quantitatively to what extent such excitation is related to the amplitude and length of the waviness is not clear, and there are apparently also experiments according to which a specifically adjusted waviness can also positively affect noise development.

Finally, the invention is based on the realization that pure simulations only at the level of calculation and simulation of targeted tooth flank modifications, including waviness, are only of limited informative value since they have no concrete reference to actually manufactured toothings, whereas holistic data with a concrete reference to manufactured toothings are also not a good starting point for a targeted analysis due to the simultaneously collaborative influence of numerous influencing factors in the form of toothing faults included in production for many reasons, the effects of which overlap in the test data of the toothing measurement.

By means of the approach according to the invention, the portion specifically used for further analysis is, however, specifically tied to the toothing manufacturing process, since it originates from the test data for this toothing, and yet the influence of the portion specifically selected in the complementary space can be determined more reliably, since other effects are at least partially suppressed.

Further advantageous configurations of the method are specified in the dependent claims.

For example, a two-dimensional complementary space could also be considered for the surface measured toothing measurement data of the surface (3-D topography data). However, the measurement could also directly provide measurement data along a (one-dimensional) path (2D test data). In a preferred design, a one-dimensional complementary space is used. In the spatial domain, a path is provided over the tooth flank for this purpose.

In one variant of the method, the direction of the path can be determined with reference to the geometric dimensions of the tooth flanks, for example via an angle to the flank line direction or to the profile direction, see also below. In another preferred variant, the path direction is set to a direction along which waviness is to be expected. In this context, the direction is preferably selected depending on specifications obtained from fine machining, in particular hard fine machining of the teeth, such as feed marks and scoring, i.e., as a function of the mesh conditions during fine machining.

In principle, the measurement data taken on one flank, such as a left or right flank, are sufficient. However, for the spatial domain, the toothing measurement data are preferably used not only for one tooth flank, but for several tooth flanks, in particular all tooth flanks (each with the same name), correspondingly for the tooth flank with a different name. The path over the tooth flank should preferably have a directional component in the profile direction, in particular should be the predominant directional component, in particular a path running in the profile direction. That is, the profile shape deviation is of particular interest for the invention since it has been found that this has a greater influence on noise emissions than flank shape deviations. On the other hand, the influence of flank shape deviations must be taken into account, and in this respect, the invention also provides for the possibility of a mandatory directional component of the path in the flank line direction, which directional component can also be the predominant directional component. It is also envisaged to use the contact path on a gear of the mesh of the gear pair with the path. As a way of displaying the contact path, instead of displaying it in the direction of the profile by following the profile over the direct course, the method of displaying the rolling length (length on the mesh line) known from gear engineering could also be chosen.

The frequency domain is preferably used as the complementary space, preferably via Fourier transformation, for example via Fourier series expansion. This results in the corresponding spectral weight of the measured deviation data for a particular frequency in the frequency domain.

The specifically selected portion can then comprise a single frequency or a group of selected frequencies, such as higher harmonics, but also the ghost frequencies described later. Since the selection is based on actual real measured data, the very sharp centering of individual frequency peaks in the frequency domain, as is usual in simulations, does not normally result. Nevertheless, the immediately adjacent frequencies can preferably be included, provided that their spectral weight lies above a predetermined limit. A person skilled in the art will easily be able to appropriately select this threshold from a representation in the frequency domain; for example, the neighboring frequencies, possibly also the next-but-one neighboring frequencies, up to the third or fourth-but-one neighboring frequencies come into consideration for this purpose.

In one variant, so-called mesh frequencies with a number of desired harmonics can be included, i.e., frequencies that can be derived from the movement frequencies of the gear pair in mesh and are to be expected, since some of them are unavoidably present anyway. These frequencies are included with their real amplitude, i.e., their real spectral weight as determined from the measured deviation. However, the mesh frequencies can also be partially or completely excluded in order to specifically select other frequencies to test their effects.

In addition, so-called ghost frequencies can also be included, i.e., frequencies that have no relation to frequencies/wavelengths that can be derived from the movement frequencies of the gear pair in mesh and from the toothing geometries of the gear pair.

In another preferred variant, it is envisaged to specifically select one or more frequencies depending on feedback from a noise measurement of the real transmission, for example from an end-of-line test station of a transmission manufacturer. It can happen that a manufacturer experimentally finds a certain interference frequency in the real transmission and wants to establish its origin. In the simplest case, where this frequency can already be clearly identified from the measurement data, the origin is relatively clear. However, the origin can be in the form of another frequency or several frequencies (beating, convolution). The method can therefore include a targeted search for frequencies and frequency combinations which (by superposition/convolution) result in the obtained feedback frequency, as well as a check of the measured spectrum for the presence of these individual frequencies of the combination/combinations. These can then be selected to test their effect independently of the frequencies that were not taken into account because they were not selected. This can lead to frequencies also being selected whose amplitudes appear less pronounced in the measured spectrum and which would therefore not be easily recognized as harmful in the spectrum.

In terms of operation, it is definitely intended for an operator to personally determine the specifically selected portion in part or in full, for example by means of a corresponding input. This could be done graphically via a touchscreen or multi-touchscreen, for example by setting intervals or windows.

However, it is also envisaged for selection programs to be provided which will determine in part or in whole the specifically selected portion. Such a selection program could scan the Fourier spectrum for frequencies lying above a threshold in terms of their spectral weight, determine these frequencies, and select them individually one after the other for further analysis or in pairs or also in multiple combinations. This means that one can specify a corresponding test grid which is then checked automatically. The identification of those frequency portions which show a measurable and possibly recurring influence on the noise emissions can then be at the end of such an automatic or semi-automatic contact analysis.

In a preferred embodiment, the transmission error is determined as part of the load-based contact analysis. However, other properties, such as force excitation, Hertzian pressure, loss, etc. can also be determined. The mating gear for simulating the contact analysis can be an ideal “master gear” or a mating gear that has also been measured.

In a further variant, a simulated portion could be superimposed on the selected portion according to the invention, for example another frequency with amplitude, wavelength and phase.

In addition, the vibration excitations are preferably determined by means of a so-called NVH (noise vibration harshness) performance, and a concrete representation of the expected noise emissions is preferably also created, for example by means of a visual representation, such as a Campbell diagram.

To generate the measurement data, a conventional gear testing machine with a non-contact or tactile sensor can be used.

It goes without saying that the specified target profile of the toothing surface can already include tooth flank modifications, such as crowning, setbacks, etc.

The invention is also protected not only in terms of process engineering, but also in the form of a software program which, when executed, carries out a contact analysis according to the invention, as well as by a corresponding analysis device and a measuring and analysis apparatus which includes a tooth testing device for determining the measurement data, which can but does not have to be located at the same location as the analysis device.

Further features, details and advantages of the invention will be apparent from the following description with reference to the accompanying figures, wherein:

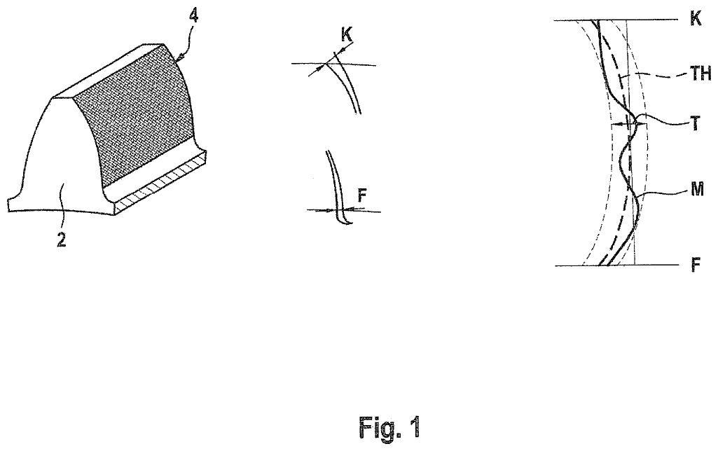

FIG. 1 is an explanatory representation of the profile deviation on a tooth flank,

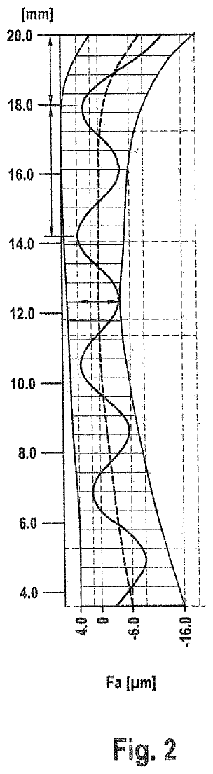

FIG. 2 shows a fictitious wave-shaped deviation,

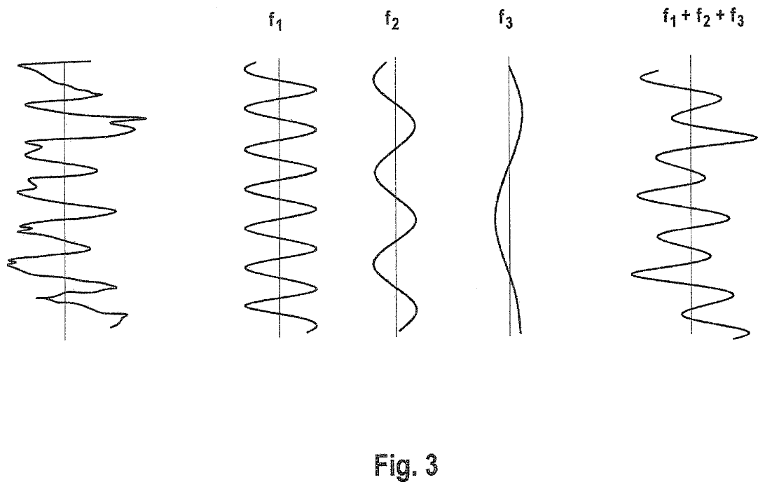

FIG. 3 shows a measured shape deviation and a superposition consisting of three frequency portions,

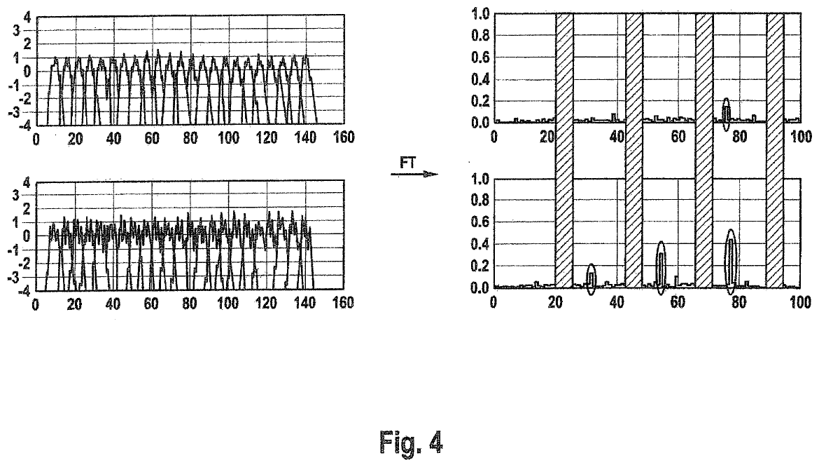

FIG. 4 shows representations of measurement signals taking into account all tooth flanks and their representation in the complementary space for left and right flanks,

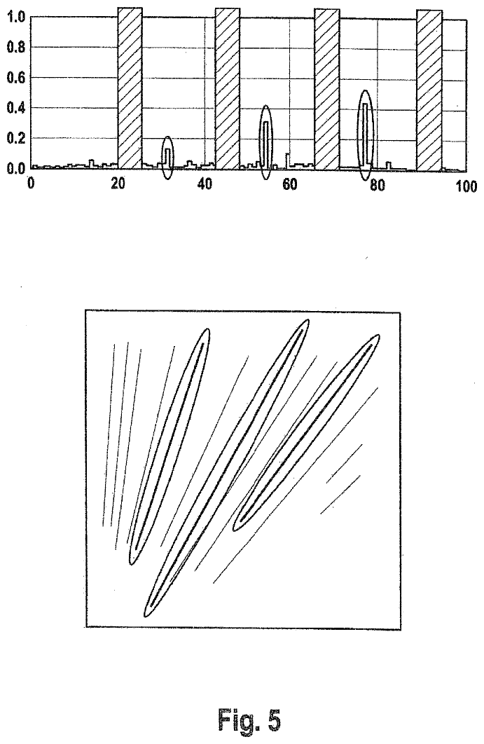

FIG. 5 shows a purely schematic representation of expected noises matching the complementary space representation in FIG. 4, bottom right, and

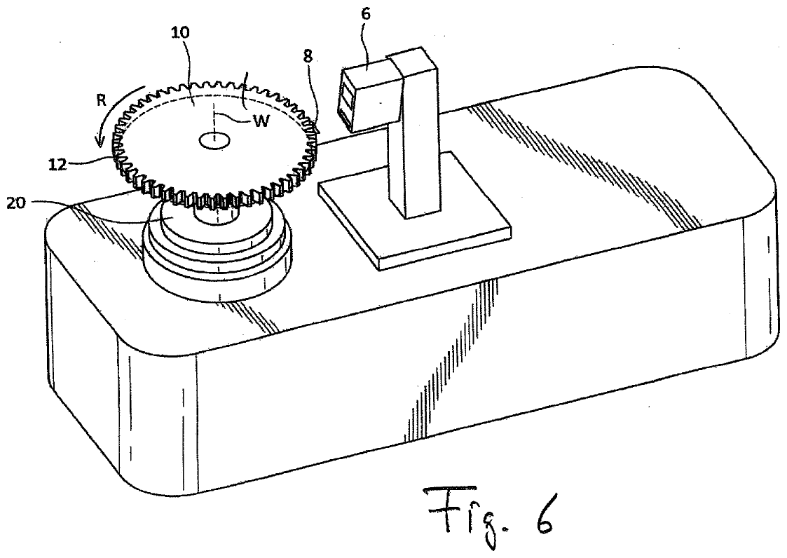

FIG. 6 shows a schematic representation of a testing device for measuring the tooth flanks of a gear by laser scanning.

To briefly explain the so-called profile deviation, this is clearly shown in FIG. 1. Thus, the tooth flank 4 of a tooth 2 of a toothing extends in the toothing width direction and in the profile direction (height direction) (FIG. 1, left), deviations from the profile can be determined at the head K and root F (FIG. 1, middle), and for a theoretically ideal tooth flank shape TH, the profile measurement M shown as an example should be within a specified tolerance window T (FIG. 1, right). The difference between the curves M and TH therefore represents the deviation between a measured tooth flank and a theoretically specified target flank.

If a fictitious virtual wave-shaped deviation is entered into a measurement diagram as shown in FIG. 2, it can be seen that wave-shaped deviations can certainly lie within the tolerance range (outer limit lines in FIG. 2). Furthermore, in FIG. 2, the three shown dimension arrows represent parameters that could define a waveform and its position, such as the wavelength (vertical distance arrow approximately between 18 and 14 mm in FIG. 2), position of a high point with respect to the head (upper distance arrow in FIG. 2 approximately between 18 and 20 mm), and (double) amplitude of the wave (horizontal distance arrow in FIG. 2). In the diagram in FIG. 2, the vertical axis corresponds to the rolling length (length on entry line), here for a left flank.

In FIG. 3 on the left, a shape deviation measured in the profile direction compared to a target profile is shown. After Fourier transformation, coefficients with corresponding amplitudes are obtained for the frequencies f₁, f₂ and f₃ given in FIG. 3, middle, whose back transformation into the spatial domain yields the sinusoids shown in FIG. 3, middle, with a constant amplitude and only one frequency. For example, the contact analysis could then only be based on the portion consisting of these three frequencies. A representation of the corresponding superposition of these three frequencies, back-transformed and displayed in spatial domain, results in the curve shown in FIG. 3 on the right; further irregularities and portions that are still recognizable in the measurement signal in FIG. 3 on the left are no longer included therein.

If the profile deviations of, for example, all teeth are measured in one section and combined according to the rolling path, the deviation in bold lines in FIG. 4 for the left flank at the top left and for the right flank at the bottom left is obtained after removing the overlapping areas; the associated representations after Fourier analysis in complementary space (frequency domain). The marked first to fourth harmonics can be seen on both flanks, although their amplitudes are different. Furthermore, it can be seen that for the specific selection, the immediately adjacent coefficients for mapping the harmonics can be included; in this selected exemplary embodiment, these are the two immediately adjacent frequency coefficients in the frequency domain.

Furthermore, it can be seen from the representation in the frequency domain in FIG. 4 on the right that there are coefficients with spectral weight above a certain threshold which lie outside the harmonics and which are circled in FIG. 4. These frequencies are referred to as ghost frequencies in the context of this application because they have no relation to frequencies/wavelengths that can be derived from the movement frequencies of the gear pair in mesh and from the toothing geometries of the gear pair, in contrast to the so-called “mesh harmonics”.

If, for example, one selects the four marked harmonics as the specifically selected portion, and optionally also none, one or more of the ghost frequencies, the influence of each individually recorded ghost frequency on the noise emissions can be obtained individually by basing the simulated contact analysis only on the corresponding specifically selected portion, and with an amplitude as it is present in the actual gear and is known after measurement.

In the illustration in FIG. 5, a comparison is shown between the spectral weight as in FIG. 4, bottom right illustration, with the result of a determination of noise emissions. The bottom diagram in FIG. 5 as the Campbell diagram is shown only very schematically for illustrative purposes but, with the elliptically outlined areas, it illustrates the connection to the three considered ghost frequencies, which is not shown in the Campbell diagram for the left tooth flank (FIG. 4, top).

Accordingly, analyses for noise emissions are possible on the basis of real measurement data with concrete reference to the toothing, which are unaffected by disturbances of other kinds, since only the specifically selected part of the deviation described above and not the deviation as a whole is taken as a basis.

FIG. 6 shows the basic principle of a gear testing machine in which the tooth flanks 12 of a toothing 10, which are clamped on a workpiece spindle 20 so as to be rotatable about the toothing axis W and are measured by means of a laser sensor 6 while rotating in the direction R, the field of view 8 of which laser sensor lies in the area of the toothing. It is understood that other testing machines can also be used, for example a machine in which the laser sensor 6 can be arranged so as to be adjustably positionable in up to three spatial directions, as described in WO 2019/083932 A1, which is incorporated by reference in this regard.

The load-based contact analysis itself can be carried out using evaluation software known to a person skilled in the art, for example the KISSsoft software by the applicant. A software implementation could, for example, be realized via a software interface in which the above-described reduction of the two-dimensional measurement data to one dimension, subsequent transformation into the Fourier space and the specific selection of only a portion of the transformed deviation in the Fourier space are carried out. It goes without saying that instead of such a software interface, an already existing known evaluation software can also be expanded for contact analysis, and still requires the measurement data of the gear testing machine as input data. However, variants are also envisaged in which some of the steps described above can still be carried out on the testing machine itself which, for example, already creates and passes on the resulting frequency spectrum.

The invention is not limited to the exemplary embodiments, but instead, the features of the following claims and above description may be essential, individually or in combination, for the realization of the invention in its various embodiments.

1. A method for determining the expected noise emissions of a gear pair, in which method the tooth flanks of a gear of the pair are measured and, from the measurement data thereby obtained, the deviation of the measured tooth flank surfaces from a predefined target profile of this surface is determined, and in which method on the basis of this deviation, a simulation in the form of a contact analysis under load is carried out for the gear pair,
characterized in that the contact analysis is not based on the deviation as a whole but only on a specifically selected portion of the deviation in the complementary space.

2. The method according to claim 1, wherein deviation data along a path over the tooth flank are determined from the surface deviation taking into account more than two tooth flanks of the gear with the same name.

3. The method according to claim 2, wherein the path has a directional component in the profile direction and runs in the profile direction or is the contact path of the gear pair.

4. The method according to claim 2, wherein the complementary space is one-dimensional, with the associated spatial domain corresponding to the path.

5. The method according to claim 1 wherein the surface deviation is subjected to a Fourier analysis.

6. The method according to claim 1 wherein the specifically selected portion comprises a spectral portion of a selected frequency or a group of selected frequencies.

7. The method according to claim 6, wherein for a selected frequency, the spectral weight of its immediate surroundings is also selected.

8. The method according to claim 1 wherein at least one closest harmonics are selected for a fundamental frequency/wavelength.

9. The method according to claim 1 wherein the selected frequency (frequencies) is/are entered with their amplitude as obtained from the transformed measured deviation.

10. The method according to claim 1 wherein frequencies are selected or also selected which have no relation to frequencies/wavelengths derivable from the movement frequencies of the gear pair in mesh and from the toothing geometries of the gear pair.

11. A method according to claim 1 wherein the deviation is displayed to an operator, and the operator determines the specifically selected portion in part or as a whole by an input.

12. The method according to claim 11, wherein the display is graphical and the input is made by setting intervals or windows.

13. The method according to claim 1 wherein the specifically selected portion is determined in part or as a whole by a selection program.

14. The method according to claim 1 wherein the rotational path error is determined during the contact analysis.

15. The method according to claim 1 wherein the contact analysis is used to create a visual representation of the expected noise emissions.

16. The method according to claim 1 wherein the measurement is carried out by a touch sensor and/or free of contact.

17. A software program for carrying out a contact analysis according to claim 1 when an analysis device is executed on a computing unit.

18. An analysis device configured to execute a contact analysis of a gear pair according to claim 1.

19. A measuring and analysis apparatus, comprising a gear testing device for measuring tooth flank surfaces, and an analysis device according to claim 18.

20. The method of claim 16 wherein said free of contact comprises optically.
